(19) United States
(12) Patent Application Publication
(10) Pub. No.: US 2026/0285103 A1
(43) Pub. Date: Sep. 24, 2026

(54) Vehicle Assists and Related Methods

(71) Applicant: Primera Pro, LLC, Provo, UT (US)

(72) Inventor: Samuel Morgan Patterson, Provo, UT (US)

(73) Assignee: Primera Pro, LLC, Provo, UT (US)

(21) Appl. No.: 19/570,465

(22) Filed: Mar. 18, 2026

Related U.S. Application Data
(60) Provisional application No. 63/774,736, filed on Mar. 19, 2025.

(51) Int. Cl. B60D 1/18; B60N 3/02

(52) U.S. Cl. CPC B60D 1/187; B60N 3/026

(57) ABSTRACT

A vehicle assist includes a wrap portion, which may include a rope, configured to wrap around a roll bar of an off-road vehicle. A strap may include a tunnel coupled thereto, and the wrap portion may be coupled through, and slidable in, the tunnel. The strap may secure one loop of the wrap portion to prevent lateral movement thereof along the roll bar (while still allowing the loop to circumferentially rotate around the roll bar), while another loop of the wrap portion remains free to move laterally along the roll bar. A line may be secured to the wrap portion (or to a handle coupled with the wrap portion) to provide a winching, pulling, or other support operation on the vehicle. The vehicle assist may also be used as a grab handle by a user when entering/exiting the vehicle or simply for support while in the vehicle.

### CROSS REFERENCE TO RELATED APPLICATIONS

This document claims the benefit of the filing date of U.S. Provisional Patent Application No. 63/774,736, entitled “Vehicle Assists and Related Methods,” naming as first inventor Samuel Morgan Patterson, which was filed on Mar. 19, 2025, the disclosure of which is hereby incorporated entirely herein by reference.

### BACKGROUND

### 1. Technical Field

Aspects of this document relate generally to handles able to be coupled with a roll bar or roll cage of an off-road vehicle. Aspects of this document relate generally to assemblies and devices configured for applying a force to an off-road vehicle to prevent or hinder the vehicle from tipping and/or to adjust the vehicle to a desired position.

### 2. Background Art

Handles exist in the art which are configured to be coupled with roll bars of an off-road vehicle, such as for a user to hold for support while entering and exiting the vehicle. Soft shackles exist in the art and have been used in off-road vehicle recovery, such as assisting in extracting a vehicle from a stuck configuration. Soft shackles have also been used to intentionally tip a vehicle, such as to assist with a tire change.

### SUMMARY

In some aspects, the techniques described herein relate to a vehicle assist, including: a wrap portion configured to wrap around a roll bar of a vehicle; and a coupler coupled with the wrap portion and configured to allow a line to be secured therewith; wherein: in a resting position the wrap portion forms a handle for a user; and in a pulling position in which the line is pulling on the coupler with a pulling force, the pulling force is aligned with a center of the roll bar.

In some aspects, the techniques described herein relate to a vehicle assist, including: a wrap portion configured to wrap around a roll bar of a vehicle; and a handle coupled with the wrap portion and configured to allow a line to be secured therewith; wherein: in a resting position the vehicle assist may be used as support for a user while entering the vehicle, exiting the vehicle, or while in the vehicle as the vehicle moves; and in a pulling position of the vehicle assist in which the line is pulling on the handle with a pulling force, the pulling force is aligned with a center of the roll bar.

In some aspects, the techniques described herein relate to a vehicle assist, wherein the wrap portion includes a single, contiguous loop.

In some aspects, the techniques described herein relate to a vehicle assist, wherein the single, contiguous loop is formed by securing a single line of rope to itself at least in part using a wrap.

In some aspects, the techniques described herein relate to a vehicle assist, wherein the wrap is a heat-shrink wrap.

In some aspects, the techniques described herein relate to a vehicle assist, wherein the wrap portion is formed of ultra-high-molecular-weight polyethylene (UHMWPE) and includes one of a rope and a braided rope.

In some aspects, the techniques described herein relate to a vehicle assist, wherein the wrap portion consists of a single line of rope secured to itself using a wrap to form the single, contiguous loop.

In some aspects, the techniques described herein relate to a vehicle assist, wherein the handle includes one or more couplers configured to selectively secure the handle in a closed configuration.

In some aspects, the techniques described herein relate to a vehicle assist, wherein, in the closed configuration, the handle forms a tunnel.

In some aspects, the techniques described herein relate to a vehicle assist, wherein the wrap portion is configured to wrap around the roll bar by saddling the wrap portion over the roll bar in a saddled configuration in which the wrap portion forms two loops around the roll bar, and wherein the handle in the closed configuration is configured to secure the wrap portion in the saddled configuration.

In some aspects, the techniques described herein relate to a vehicle assist, further including a strap coupled with the wrap portion and configured to be tightened around the roll bar to prevent a first part of the wrap portion from sliding laterally along the roll bar.

In some aspects, the techniques described herein relate to a vehicle assist, further including a tunnel securing the strap with the first part of the wrap portion, wherein the first part of the wrap portion is slidable within the tunnel, allowing the first part of the wrap portion to slide circumferentially around the roll bar while being prevented from sliding laterally along the roll bar.

In some aspects, the techniques described herein relate to a vehicle assist, wherein a second part of the wrap portion is free to slide laterally along the roll bar while the first part of the wrap portion is prevented from sliding laterally along the roll bar.

In some aspects, the techniques described herein relate to a vehicle assist, wherein the strap includes one or more grip portions configured to contact the roll bar when the strap is tightened around the roll bar.

In some aspects, the techniques described herein relate to a vehicle assist, wherein the strap includes one or more hook-and-loop fasteners configured to facilitate the strap being tightened around the roll bar.

In some aspects, the techniques described herein relate to a method of use of a vehicle assist, including: saddling a wrap portion of the vehicle assist around a roll bar of a vehicle in a saddled configuration so that the wrap portion forms two loops around the roll bar; securing a handle of the vehicle assist in a closed configuration to secure the wrap portion in the saddled configuration; while the vehicle assist is in a resting configuration, using the handle as support for a user while one of: entering the vehicle; exiting the vehicle; and sitting within the vehicle; and providing a pulling force on the handle with a line, the pulling force placing the vehicle assist in a pulling position in which the pulling force is aligned with a center of the roll bar.

In some aspects, the techniques described herein relate to a method, wherein the wrap portion includes a single, contiguous loop formed by securing a single line of rope to itself.

In some aspects, the techniques described herein relate to a method, further including using the pulling force to prevent the vehicle from tipping over while the vehicle traverses a slanted surface.

In some aspects, the techniques described herein relate to a method, further including using the pulling force to intentionally tip the vehicle enough to raise a tire of the vehicle off a ground surface to remove the tire.

In some aspects, the techniques described herein relate to a method, further including using the pulling force to extract the vehicle from a stuck configuration.

General details of the above-described implementations, and other implementations, are given below in the DESCRIPTION, the DRAWINGS, the CLAIMS, and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a side view of a prior art vehicle assist and corresponding elements;

FIG. 2 is a simplified side view of a vehicle assist and corresponding elements;

FIG. 3 is a rear view of a vehicle being assisted with the use of the vehicle assist of FIG. 4;

FIG. 4 is a top, perspective view of a vehicle assist in an uninstalled configuration;

FIG. 5 is a perspective view of the vehicle assist of FIG. 4 in an installed configuration; and

FIG. 6 is a top, perspective view of elements of the vehicle assist of FIG. 4 with a strap thereof flipped over.

### DESCRIPTION

Implementations/embodiments disclosed herein (including those not expressly discussed in detail) are not limited to the particular components or procedures described herein. Additional or alternative components, assembly procedures, and/or methods of use consistent with the intended vehicle assists and related methods may be utilized in any implementation. This may include any materials, components, sub-components, methods, sub-methods, steps, and so forth.

Off-roading is a popular activity, but precaution must be taken in certain off-roading scenarios. Off-road vehicles can sometimes become stuck in mud or sand or other elements. Some off-road vehicles may tip over in certain circumstances. In such scenarios, it can be useful to have a handle or winch point or the like to be able to apply a pulling force on the off-road vehicle (such as using a winch or another vehicle) to extract the off-road vehicle from its stuck or tipped configuration. Additionally, in some cases, a rope or line or the like may be able to be secured to an off-road vehicle preemptively so as to prevent the vehicle from tipping over while traversing uneven terrain.

Referring now to FIG. 1, a prior art vehicle assist 100 is representatively illustrated. Prior art vehicle assist 100 includes a handle portion 102 and a wrap portion 104 which is coupled with the handle portion and wrapped around a roll bar 50 of an off-road vehicle. The roll bar is illustrated in cross-section. The center 52 of the roll bar is illustrated, and it is seen that a line 110 (such as a winch line, rope, tow strap, chain, or the like) is coupled with the handle portion 102 and may be used to provide a pulling or stabilizing force (such as to help extract the vehicle from a stuck configuration). The resting position of handle portion 102 is shown in dashed lines. In the pulling position, when the line 110 is pulling on the handle portion 102, it may be seen that there is a distance 120 between the pulling force and the center of the roll bar. This creates a moment arm during a pulling action/force, which may be undesirable.

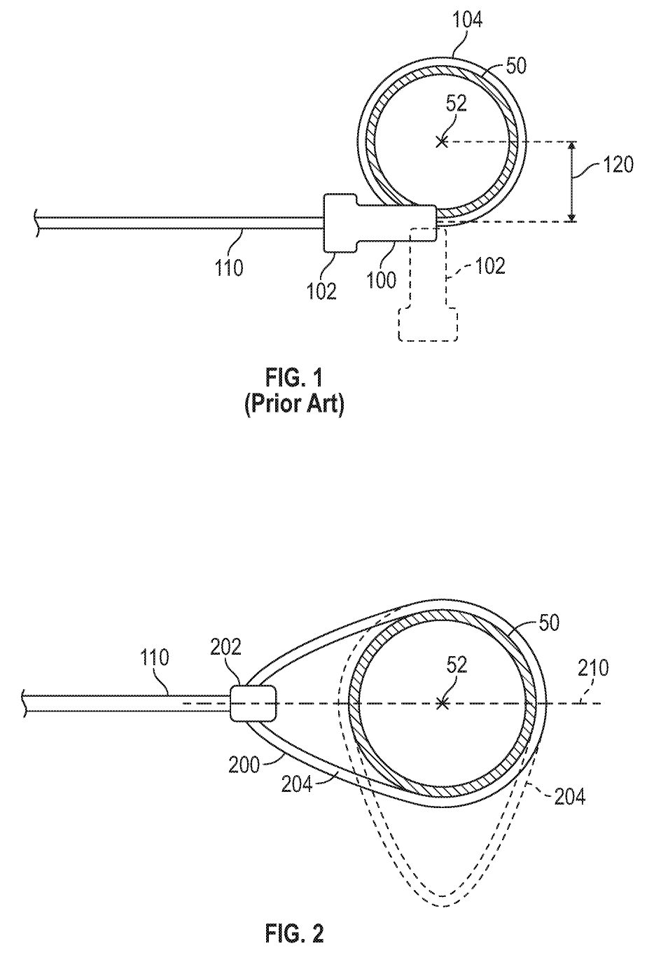

Referring now to FIG. 2, a vehicle assist 200 is representatively illustrated. Vehicle assist 200 includes elements of vehicle assist 400, which will be discussed hereafter, but is a simplified version with some elements modified or omitted for ease of viewing other elements/functions. Vehicle assist 200 includes a coupler 202, which is used to couple the line 110 therewith to provide a pulling force, and a wrap portion 204, which wraps around the roll bar 50. The center 52 is again shown, and dashed line 210 representatively illustrates that during the pulling motion/action, the pulling force is aligned with the center 52, so that no moment arm is present. The wrap portion 204 is also illustrated in dashed line to show its resting position when not being used for a pulling action. In this resting position, the wrap portion 204 conveniently forms a handle that a user may use, for example, as support while entering or exiting the off-road vehicle, or simply as support while maneuvering the vehicle or sitting in the vehicle.

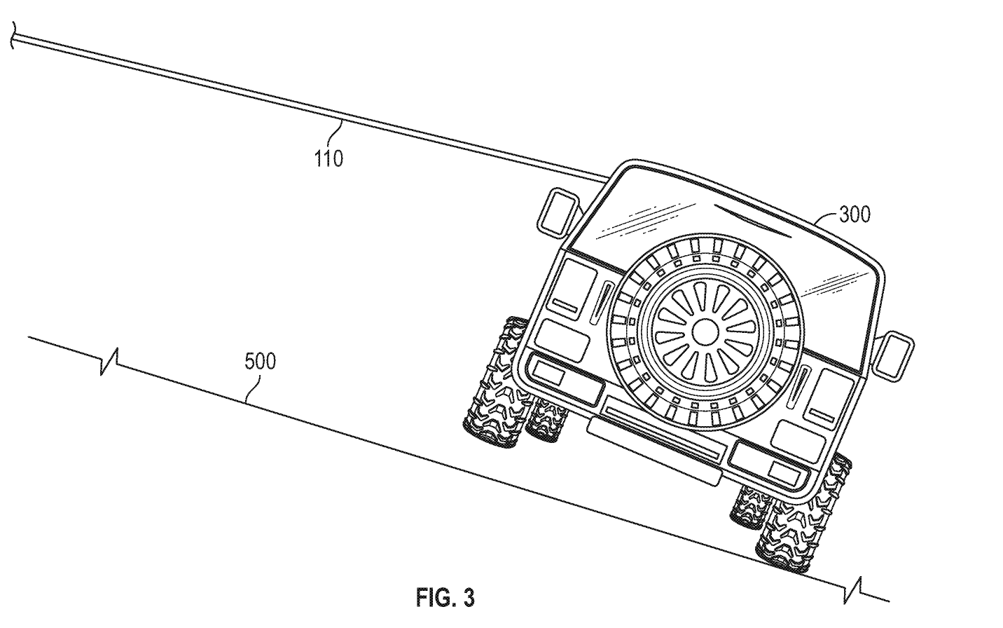

FIG. 3 representatively illustrates how the vehicle assist 200 or 400 could be used to assist an off-road vehicle 300. In FIG. 3, the off-road vehicle 300 is traversing a slanted surface 500, and the vehicle has begun to tip such that the left (driver’s side) tires are off the ground. The line 110 is, however, secured to the vehicle assist 200 or 400 (not visible in FIG. 3, but secured to the vehicle’s roll bar) and is otherwise secured to some other element off-picture (such as a tree or a winch or another vehicle, or so forth) and prevents the vehicle from tipping further once the line is taut (as it is in FIG. 3). This allows the vehicle to traverse the slanted surface without fully tipping over. FIG. 3 is a simplified drawing, omitting some elements for simplicity. For example, the line 110 may be secured to the vehicle assist 400 or 200 using a steel or metal coupling element, such as a hook-like element, or may be tied thereto, or otherwise secured thereto—but as such elements/mechanisms are generally known in the off-roading art, they need not be shown in the drawings to provide enablement of the vehicle assist 400 or vehicle assist 200.

There are other instances/scenarios in which the vehicle assist 200 or 400 may be used. For example, even on a flat surface, a vehicle assist could be secured to a roll bar, and a winch or other vehicle used to pull on a line secured thereto, so as to intentionally tip the vehicle in a direction (for example, to make changing a tire easier on the side that is tipped off the ground, by raising that tire off the ground). The vehicle assist could also be secured to another part of the vehicle or the roll bar (for example, a front or back roll bar, or front or back portion thereof, instead of a side roll bar or side portion of a roll bar) so as to pull the vehicle forward or backward to extract the vehicle from a stuck configuration. Other configurations and uses are possible.

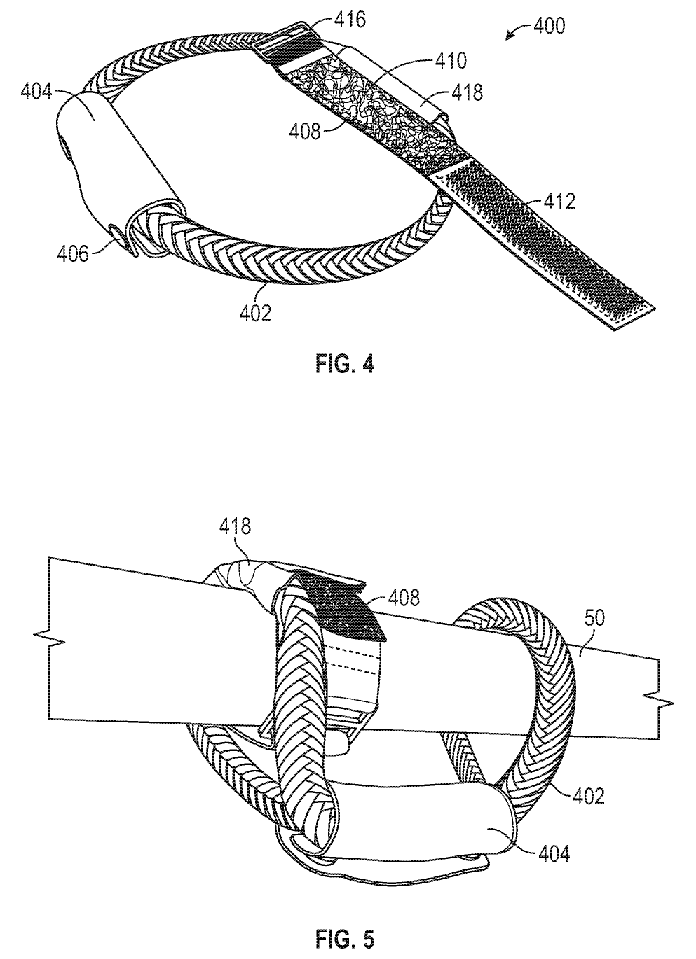

Referring now to FIGS. 4-6, various views of a vehicle assist 400 are shown. In FIG. 4, it can be seen that the vehicle assist 400 includes a wrap portion 402 configured to wrap around a roll bar 50 (as seen in FIG. 5). The wrap portion could, in implementations, be made of a variety of materials and could have a variety of configurations. However, in implementations, the wrap portion is a rope (or braided rope) formed of ultra-high-molecular-weight polyethylene (UHMWPE) (which may be marketed under the name DYNEEMA). In implementations, the wrap portion forms a single, contiguous loop of UHMWPE. This may be accomplished, by non-limiting example, by tucking the ends of a single rope into one another and securing them tightly using a wrap 420 (which may, for example, be a heat-shrink wrap). The wrap 420 may, for example, be an industrial-grade heat-shrink element that covers the local area where the two ends of the rope intersect into each other, and may provide a visually clean, finished aesthetic (it may also inhibit someone from separating the two ends of the rope from one another).

In implementations, there is no adhesive or melt bonding or the like between the ends of the rope (though, in implementations, these could be used). Instead, friction between individual rope strands keeps the two ends from separating (this may be seen as analogous to the function of a Chinese finger trap). The harder the force attempting to pull the two ends apart, the higher the friction between the individual intersecting rope strands. In implementations, there are approximately eight inches of buried or tucked material per each end of the rope, for sixteen total inches once the contiguous loop is formed. In other implementations, there are approximately six to twelve inches of buried or tucked material per each end of the rope, for twelve to twenty-four inches once the contiguous loop is formed. In other implementations, there are approximately three to six inches of buried or tucked material per each end of the rope, for six to twelve inches once the contiguous loop is formed. In other implementations, there may be any amount of buried or tucked material between three to twelve inches per each end of the rope. The buried/tucked material is, in implementations, not visible from the outside.

Forming the wrap portion 402 of one contiguous loop may, in implementations, be useful for avoiding high-stress points (or high localized stresses) in the wrap portion, so that internal stresses of the wrap portion are evenly (or substantially evenly) distributed throughout. The manner of coupling the wrap portion 402 around the roll bar, by saddling it over the roll bar (so that it forms two loops around the roll bar), may also contribute to maximizing the strength of the vehicle assist 400, by also helping to evenly distribute stress evenly throughout the wrap portion 402.

Using a contiguous loop is also useful in that there is no higher-diameter part of the wrap portion. With prior art soft shackles, for example, there is a “monkey-fist” portion that is higher diameter. Such higher-diameter portions may make it difficult to use soft shackles in tight-fitting circumstances (for example, on a roll cage where the space between the roll cage and the roof is very tight). In such tight circumstances, however, the constant, small diameter of the wrap portion 402, throughout its full length, may allow the vehicle assist 400 to easily be used—easily installed and uninstalled—as desired for extraction/support functions and so forth.

The wrap portion, being formed of UHMWPE in some cases (or of other very strong materials in other cases), is configured to bear the full weight/force (or substantially the full weight/force) applied to the vehicle assist 400 during an extraction or recovery or support operation. Paracord grab handles (configured to be coupled to a roll bar) do exist in the art, but they are fundamentally different from vehicle assist 400, at least in their strength and in how they connect to the roll bar. Paracord alone is mildly strong, but in comparison to the example 3/8” UHMWPE rope of the wrap portion 402, it pales in comparison. Paracord handles also attach to a roll bar/cage via webbing straps, rather than bearing weight through the cordage itself. When such a handle is pulled on, the relatively weak webbing strap is bearing all the forces.

As can be seen in FIG. 5, in an installed configuration, the wrap portion 402 sits in a saddle configuration around the roll bar 50. A handle 404 may be secured around two portions of the wrap portion 402 to secure them close to one another and to otherwise form a single point at which a line 110 may be secured to, in order to perform a pulling or stabilizing operation. The handle 404, in implementations, has couplers 406 to selectively secure the handle to a closed configuration (and it can be seen that in the closed configuration, the handle forms a tunnel through which two portions of the wrap portion pass through, or in other words, the wrap portion passes through this tunnel twice). The couplers 406, in some cases, may be snaps or the like, but in some cases, they are magnetic couplers. In some implementations, the vehicle assist 400 may be installed in a way so as not to inhibit or negatively affect the function of roll bar side curtain airbags. In some cases, magnetic couplers may help facilitate this functionality – the magnets being configured to separate/decouple upon deployment of a roll bar side curtain airbag, so as not to inhibit or negatively affect the airbag’s functionality. In implementations, proper placement/installation of the vehicle assist 400 may be required so as not to interfere with the roll bar side curtain airbag. The handle 404, in addition, provides a convenient, functional, and comfortable grab handle for a user to hold onto while entering/exiting the vehicle. Accordingly, the vehicle assist 400 serves a dual purpose of providing a winch/support point and, also, a simple grab handle for a user to support himself.

In some cases, the handle 404 could be omitted, though in implementations it is included for the advantages/features described herein.

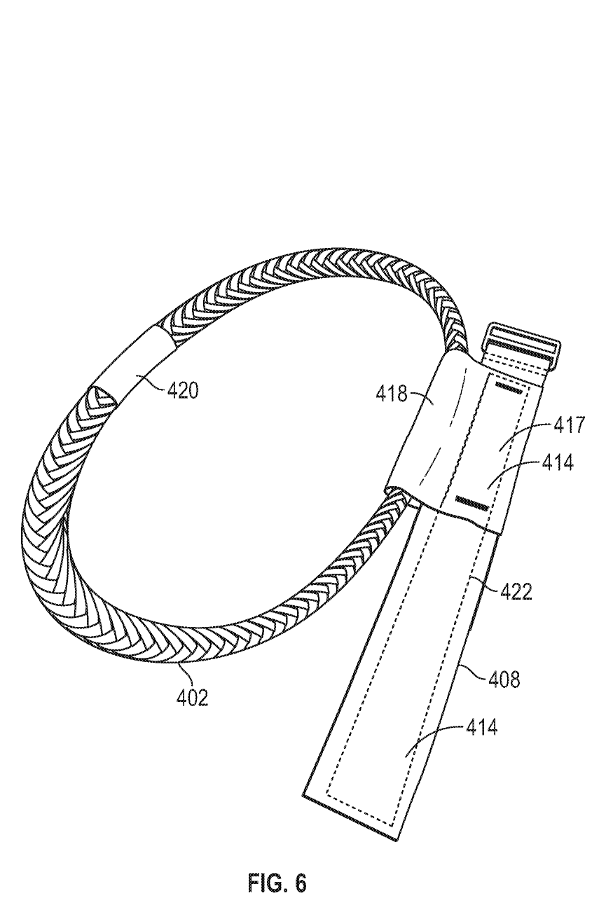

A strap 408 is secured to the wrap portion 402 using a tunnel 418. The tunnel may be formed using a layer 417 (which may also be called a sheet) that is folded upon itself and secured to the strap using stitching 422. There are other methods of providing the tunnel, and this is only one example. The wrap portion 402 passes through the tunnel and is slidable therein. The stitching 422 may also secure a first portion 410 of a hook-and-loop fastener, and a second portion 412 of a hook-and-loop fastener, to the strap. A buckle 416 is present at an end of the strap, and the second portion 412 may be passed therethrough and doubled back upon itself to be secured to the first portion 410. The underside of the strap, visible in FIG. 6, may include one or more grip portions 414. The grip portions may be formed of a rubber or other material configured to have high friction relative to the roll bar. Indeed, the tunnel itself may be formed from a sheet of such a high-friction material, or not. The tunnel, however, may be configured to have low friction relative to the wrap portion 402, so that the wrap portion can easily slide therein. This allows for the wrap portion 402 to swing side to side, up to one-hundred-eighty degrees of swinging, to easily accommodate winching from various angles (in other words, the wrap portion is free to slide circumferentially around the roll bar). It is common, when performing a winching operation, to apply the winching force from a variety of angles (depending on the location of a tree, rock, vehicle, etc. that is anchored to). The ability of the wrap portion 402 to slide within the tunnel to pivot/swing around the center of the roll bar accommodates different winch angles. Keeping the pulling force in line with the center 52 of the roll bar 50 prevents a moment arm from forming, which moment arms can wear out or damage a vehicle assist more quickly. As seen in FIGS. 1-2, the vehicle assists 200/400 pivot about the center 52 of the roll bar, instead of the bottom of the roll bar, and thus such wear/damage is reduced.

The one or more grip portions 414 (on the underside of the strap) contact the roll bar when the strap is tightened and inhibit lateral movement of the strap, preventing it from sliding along the roll bar in the installed configuration (as in FIG. 5). The one or more grip portions 414 thus help to hold the strap itself in place, which in turn holds one end of the wrap portion 402 in place as well. This prevents the vehicle assist 400 from sliding up and down the roll cage during a pulling/support operation, which results in more stable support operations. It also prevents the vehicle assist 400 from sliding when a user uses it simply as a grab handle (for example, if the vehicle is parked on an incline and the user uses the vehicle assist 400 as a grab handle, the device may tend to slide down toward the lower end of the roll bar without the one or more grip portions 414). In some cases, however, the one or more grip portions 414 may be omitted, and the user may be able to sufficiently tighten the strap so as to prevent such sliding. The one or more grip portions 414, however, may make such sliding even less possible/likely, and so may be desirable.

While one loop of the wrap portion 402 (looped around the roll bar 50) is secured in place using the strap and tunnel, the other loop of the wrap portion is loose, so that it may freely slide back and forth along the roll bar. Upon winching (or otherwise applying force) to the handle 404, the two loops naturally move closer together. The loop passing through the tunnel is constrained from such lateral movement, but the other loop is free to slide laterally. This alleviates unnecessary stresses on the strap, which is inherently weaker than the wrap portion 402, and in implementations may also help to evenly distribute stresses throughout the wrap portion 402. In the winching position (or during a winching or pulling/support operation), the two loops of the wrap portion 402 may be close to each other, as opposed to being spaced apart as in FIG. 5. When a winching/pulling operation is not being done, however, the vehicle assist 400 may revert to a configuration such as that of FIG. 5, with the loops distanced from one another further, so as to provide a convenient grab handle for a user.

The configurations and details of the vehicle assist 400 described above may, in implementations, make it the strongest handle and/or the strongest vehicle assist in the off-road industry—even stronger than handles/vehicle assists formed of metal. Strength tests have been performed on a version of the vehicle assist 400, and it has been found to have a maximum breaking strength (MBS) of (or of about) 45,000 pounds, roughly 7.5 times the weight of a four-door JEEP WRANGLER. Accordingly, in implementations, the vehicle assist 400 is configured to support the full weight of the off-road vehicle (and more) without breaking. It is believed to be the only grab handle in the off-road industry that can be winched on and that can support the full weight of the vehicle.

The vehicle assist 200 and vehicle assist 400 may be directly secured to the metal of a roll bar or roll cage, or, if a foam or other padding surrounds a roll bar or roll cage, may be directly secured around such padding, and may still function as detailed herein. The one or more grip portions 414 may be configured to have high friction with such padding, and/or the strap may be configured to be long enough to be secured in place whether such padding is present or absent.

The various devices and/or assemblies disclosed herein and their elements, sub-elements, sub-assemblies, and so forth may be formed from any materials that will feasibly allow, facilitate, and/or otherwise not hinder their respective functions as described herein. For example, any of the devices, elements, or sub-elements may, wherever possible, be formed of metals, polymers, composites, ceramic materials, fabrics, and so forth.

Furthermore, there are a variety of ways in which the various elements may be directly or indirectly coupled together. Notwithstanding the specific ways in which elements are depicted as being coupled together herein, these same elements could, wherever feasible, be joined together in any of the following ways: manually removably coupled together, such as using a friction fit, hook and loop fasteners, snaps, buttons and corresponding holes/slits, zippers, a reusable adhesive, manually removable bolts and nuts or screws or other threaded fasteners, mating threads implemented on any components, and any other type of manually removable coupling mechanism; or fixedly/permanently coupled together, such as using a permanent adhesive, rivets, welding, melt joining or heat bonding, sewn elements, stitching, seams, and any other type of permanent coupling mechanism that is not manually removable. Manually removable, as defined herein, refers to the ability to remove a coupling using manual force, either using hands alone or using non-powered hand tools.

The above-described elements may, in implementations, be configured or arranged in a variety of arrangements, each arrangement with its own advantages, as will be understood by the practitioner of ordinary skill in the art, notwithstanding the specific example arrangements which are discussed above and representatively illustrated in the drawings.

While each individual above-described element may be configured as shown in the drawings and/or as discussed above, these are only representative examples, and other configurations are possible for any individual element, with various advantages and tradeoffs, as will be understood by the practitioner of ordinary skill in the art.

In places where the phrase “one of A and B” is used herein, including in the claims, wherein A and B are elements, the phrase shall have the meaning “A and/or B.” This shall be extrapolated to as many elements as are recited in this manner, for example, the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of vehicle assists and related elements and methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation, no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases, a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order—such claims and descriptions are intended to cover the steps performed in any order, except any orders which are technically impossible or not feasible. However, in some implementations, method steps may be performed in the order(s) in which the steps are presented herein, including any order(s) presented in the claims.

What is claimed is:

1. A vehicle assist, comprising:
a wrap portion configured to wrap around a roll bar of a vehicle; and
a coupler coupled with the wrap portion and configured to allow a line to be secured therewith;
wherein:
in a resting position, the wrap portion forms a handle for a user; and
in a pulling position, in which the line is pulling on the coupler with a pulling force, the pulling force is aligned with a center of the roll bar.

2. A vehicle assist, comprising:
a wrap portion configured to wrap around a roll bar of a vehicle; and
a handle coupled with the wrap portion and configured to allow a line to be secured therewith;
wherein:
in a resting position, the vehicle assist may be used as support for a user while entering the vehicle, exiting the vehicle, or while in the vehicle as the vehicle moves; and
in a pulling position of the vehicle assist, in which the line is pulling on the handle with a pulling force, the pulling force is aligned with a center of the roll bar.

3. The vehicle assist of claim 2, wherein the wrap portion comprises a single, contiguous loop.

4. The vehicle assist of claim 3, wherein the single, contiguous loop is formed by securing a single line of rope to itself at least in part using a wrap.

5. The vehicle assist of claim 4, wherein the wrap is a heat-shrink wrap.

6. The vehicle assist of claim 3, wherein the wrap portion is formed of ultra-high-molecular-weight polyethylene (UHMWPE) and comprises one of a rope and a braided rope.

7. The vehicle assist of claim 3, wherein the wrap portion consists of a single line of rope secured to itself using a wrap to form the single, contiguous loop.

8. The vehicle assist of claim 2, wherein the handle comprises one or more couplers configured to selectively secure the handle in a closed configuration.

9. The vehicle assist of claim 8, wherein, in the closed configuration, the handle forms a tunnel.

10. The vehicle assist of claim 8, wherein the wrap portion is configured to wrap around the roll bar by saddling the wrap portion over the roll bar in a saddled configuration, in which the wrap portion forms two loops around the roll bar, and wherein the handle, in the closed configuration, is configured to secure the wrap portion in the saddled configuration.

11. The vehicle assist of claim 2, further comprising a strap coupled with the wrap portion and configured to be tightened around the roll bar to prevent a first part of the wrap portion from sliding laterally along the roll bar.

12. The vehicle assist of claim 11, further comprising a tunnel securing the strap with the first part of the wrap portion, wherein the first part of the wrap portion is slidable within the tunnel, allowing the first part of the wrap portion to slide circumferentially around the roll bar while being prevented from sliding laterally along the roll bar.

13. The vehicle assist of claim 11, wherein a second part of the wrap portion is free to slide laterally along the roll bar while the first part of the wrap portion is prevented from sliding laterally along the roll bar.

14. The vehicle assist of claim 11, wherein the strap comprises one or more grip portions configured to contact the roll bar when the strap is tightened around the roll bar.

15. The vehicle assist of claim 11, wherein the strap comprises one or more hook-and-loop fasteners configured to facilitate the strap being tightened around the roll bar.

16. A method of use of a vehicle assist, comprising:
saddling a wrap portion of the vehicle assist around a roll bar of a vehicle in a saddled configuration so that the wrap portion forms two loops around the roll bar;
securing a handle of the vehicle assist in a closed configuration to secure the wrap portion in the saddled configuration;
while the vehicle assist is in a resting configuration, using the handle as support for a user while one of entering the vehicle, exiting the vehicle, and sitting within the vehicle; and
providing a pulling force on the handle with a line, the pulling force placing the vehicle assist in a pulling position in which the pulling force is aligned with a center of the roll bar.

17. The method of claim 16, wherein the wrap portion comprises a single, contiguous loop formed by securing a single line of rope to itself.

18. The method of claim 16, further comprising, using the pulling force, preventing the vehicle from tipping over while the vehicle traverses a slanted surface.

19. The method of claim 16, further comprising, using the pulling force, intentionally tipping the vehicle enough to raise a tire of the vehicle off a ground surface to remove the tire.

20. The method of claim 16, further comprising, using the pulling force, extracting the vehicle from a stuck configuration.
